(19) United States
(12) Patent Application Publication
(10) Pub. No.: US 2010/0211468 A1
(43) Pub. Date: Aug. 19, 2010

(54) Processor-Implemented System And Method Of Remotely Manipulating A Cooking Appliance

(76) Inventor: Manfred Breunig, Schongau (DE)

Correspondence Address: PATENT GROUP 2N;JONES DAY, NORTH POINT, 901 LAKESIDE AVENUE, CLEVELAND, OH, 44114, US

(21) Appl. No.: 12/713,768

(22) Filed: Feb. 26, 2010

Related U.S. Application Data
(63) Continuation of application No. PCT/DE2008/001379, filed on Aug. 19, 2008.

(30) Foreign Application Priority Data
Aug. 27, 2007 (DE) 102007040652.7

(51) Int. Cl. G06Q 50/00; A47J 36/00; G01S 19/42

(52) U.S. Cl. 705/15; 99/325; 99/332; 342/357.25

(57) ABSTRACT

Systems and methods are presented for adjusting a cooking program that is to be executed in a cooking chamber of a cooking appliance. At least one of a plurality of parameters relating to a product to be cooked can be adjusted by means of at least one first display and control device. A parameter may identify a type of product to be cooked, a preparation of the product to be cooked, and a degree of cooking. An electronic menu and a mobile telephone for carrying out such systems and methods are also described.

### CROSS-REFERENCE TO RELATED APPLICATIONS

This application is a continuation of PCT Application No. PCT/DE2008/001379 filed on Aug. 19, 2008, and entitled “Method for Adjusting a Cooking Program, Electronic Menu, and Mobile Telephone Therefor.” This application claims priority to German Application No. 10 200 652.7 filed on Aug. 27, 2007. The entirety of both of which is herein incorporated by reference.

### TECHNICAL FIELD

The present disclosure relates generally to a method for adjusting a cooking program using a remote control device.

### BACKGROUND

Generic methods for computer aided cooking involving a degree of internal and external cooking can be adjusted by means of a display and control device arranged on a cooking appliance. While such methods have proved worthwhile in principle, they have a drawback that the user's wishes are often only fulfilled with a time delay and sometimes even incorrectly.

### SUMMARY

Systems and methods are provided for adjusting a cooking appliance by adjusting a first parameter related to a product to be cooked using a first remote control device. A transmitted selection for the first parameter related to a product to be cooked is received at the cooking appliance, the selection being made using a display at a remote control device. A climate at the cooking appliance is automatically generated based on the first parameter. Loading of a product for cooking at the cooking appliance is prompted upon generation of the climate, and upon loading of a product, the product is automatically prepared based on the first parameter.

### BRIEF DESCRIPTION OF THE DRAWINGS

FIG. 1 is a block diagram depicting a system for adjusting a cooking appliance.

FIGS. 2A and 2B depict the first display and control device as an electronic menu and a mobile telephone, respectively.

FIG. 3 depicts actions that may be taken by a cooking appliance.

FIG. 4 depicts actions that may be taken by a cooking appliance upon receipt of location data from a display and control device.

### DETAILED DESCRIPTION

Systems and methods are provided for enabling a user to directly select a type of product to be cooked and preparation of the product to be cooked and/or a degree of cooking (i.e., a desired dish) so that waiting times from placing the order until the receipt of the dish will be reduced, the user's wishes will be recorded in a targeted manner, and errors due to misunderstood or incorrect orders will be reduced since any further interfaces between the user and the cooking appliance, such as a waiter at a restaurant are eliminated.

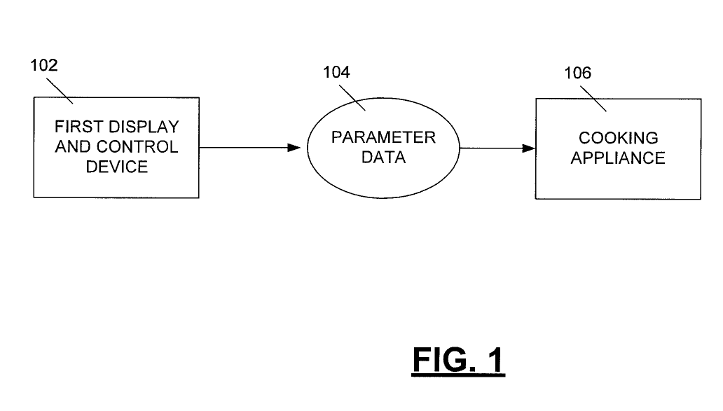

FIG. 1 is a block diagram depicting a system for adjusting a cooking appliance. This may be achieved using a first display and control device 102 that graphically displays each parameter of the product to be cooked. The first display and control device 102 can be actuated remotely from the cooking appliance and can transmit data 104 to the cooking appliance 106. For example, at least first data 104 for adjusting parameters of the product to be cooked is transmitted from the first display and control device 102 to the cooking appliance 106. A specific climate is generated in the cooking chamber in dependence of said at least first data. A request for loading the product that is to be cooked is provided according to the first data or a corresponding automatic loading process is initiated when the specific climate has been obtained in the cooking chamber. A cooking program determined by at least the first data is executed once the specific product to be cooked has been loaded.

Additional parameters may be provided by the remote first display and control device. For example, a parameter of the product to be cooked could be an addition to the product to be cooked (e.g., a side-dish, such as broccoli, potatoes, or the like, and/or a sauce, such as Béarnaise sauce, hollandaise sauce, or the like).

The parameters of the product to be cooked may be displayed on the first display and control device by means of one or more symbols or pictographs. In addition, second data, relating to the time, such as the time of day, may be transmitted by the first display and control device. Further, third data relating to the place of use, in particular to the geographical position or a table at a restaurant, of the first display and control device may be transmitted as well as fourth data for identifying and/or validating the first display and control device.

In this context, the second, third, and/or fourth data are used together with the first data to determine the product to be cooked and the climate of the cooking appliance, in particular relating to the temperature and/or humidity within the cooking chamber. The second, third, and/or fourth data may also be used to initialize the request for loading or initiation of the loading process, in particular relating to the way and/or time of loading. Furthermore, the first, second, third, and/or fourth data may be checked for plausibility to ensure that the input data makes sense and/or authorization to access the cooking appliance.

The first, second, third, and/or fourth data may be displayed on a second display and control device, preferably arranged on the cooking appliance. The data may also be stored in a storage device and/or changed.

The parameters of the product to be cooked, selected by means of the first display and control device, may be exported from the cooking appliance via the Internet, by radio, and/or from a storage device, such as in the form of a USB stick or the like. Furthermore, the first display and control device may communicate with the cooking appliance by means of a cable, by radio, via an Intranet, or the Internet.

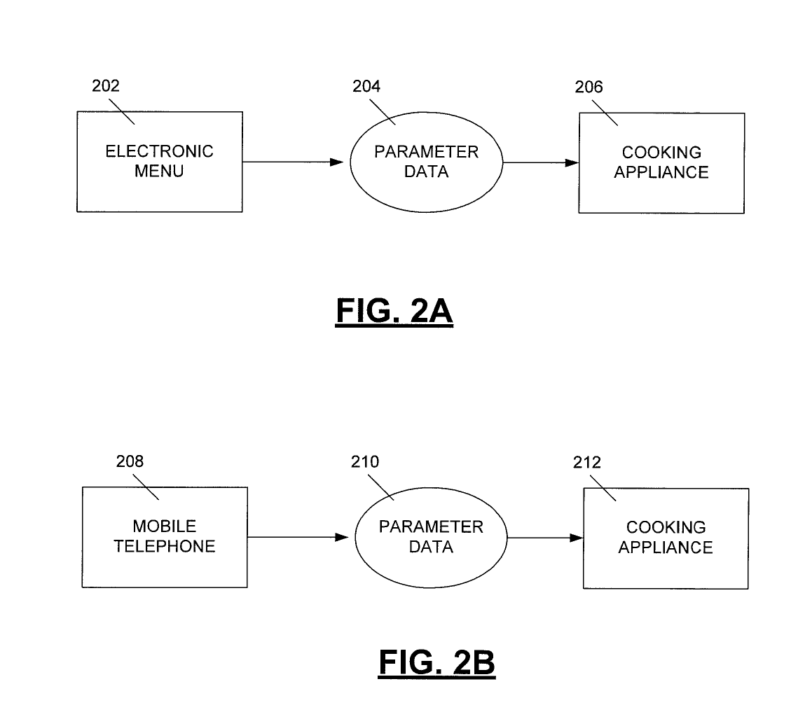

FIGS. 2A and 2B depict the first display and control device as an electronic menu and a mobile telephone, respectively. The first display and control device may be electronic menu 202 or a mobile telephone 208, each of which serves to provide a first display and control device for carrying out the described methods.

Thus, guests at a restaurant can each create their desired dish at a distance from a cooking appliance, which is for example located in a kitchen separated from the dining room of the restaurant, by selecting at least one parameter of the product to be cooked by means of a display and control device. For example, the display and control device may be in the form of an electronic menu or the guest's mobile telephone. The selected parameters may then be directly transmitted to the cooking appliance for cooking the dish. For example, four parameters of the product to be cooked may be adjusted for creating a desired dish, specifically relating to a type of product to be cooked, a preparation of the product to be cooked, a degree of cooking, and an addition to the product to be cooked.

As an illustration, an electronic menu can be allocated to each table of a restaurant. A guest in such a restaurant can first select the operating language on the electronic menu and then create his or her desired dish by adjusting parameters of the product to be cooked. The guest can, for instance, first select a type of product to be cooked from the electronic menu, (i.e., a type of dish or type of menu, such as “fish”). Subsequently, a type of preparation for the selected fish can be set as a further cooking parameter, such as “fry fish”, for example. In a next step, the guest in the restaurant can adjust a desired degree of cooking, such as “crusty” in case of fried fish, for example. In a last step, a side-dish can then be selected by adjusting a further parameter of the product to be cooked, (i.e., an addition to the product to be cooked, such as potatoes). Once all parameters of the product to be cooked have been adjusted, the guest at the restaurant can directly transmit his/her order for a desired dish to a cooking appliance of the restaurant.

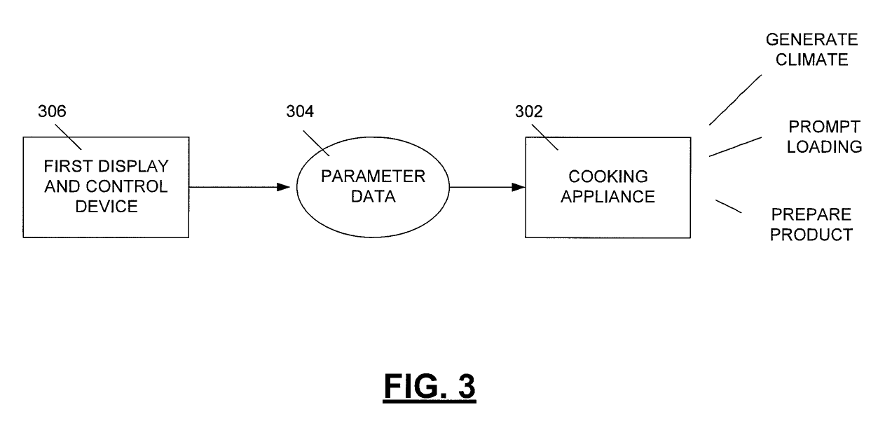

FIG. 3 depicts actions that may be taken by a cooking appliance. The cooking appliance 302, which may be a combi-steamer where the product to be cooked can be exposed to hot air and/or steam, can contain a computing unit which processes the culinary wish described above to calculate an optimum time for loading the product to be cooked which is required for the desired dish as well as the suitable climate and cooking program. In a conventional restaurant which offers meals à la carte, the various items of food are mostly pre-cooked and cooking is completed in a finishing process once a user has placed an order.

As soon as cooking of a dish is completed, the display and control device 304 of the cooking appliance indicates that the dish should be removed and served at the table from which the electronic menu used to order the desired dish was transmitted.

An operator of a cooking appliance which communicates with electronic menus need only place certain pre-cooked items of food within the cooking chamber of the cooking appliance once the operator has been requested to do so, for example, by means of a second display and control device arranged on the cooking appliance. The operator may remove the items once cooking is completed, and the items can be served. Such a process avoids complex adjustments of the cooking appliance including potential errors. In addition, the number of staff in restaurants can be reduced in this way.

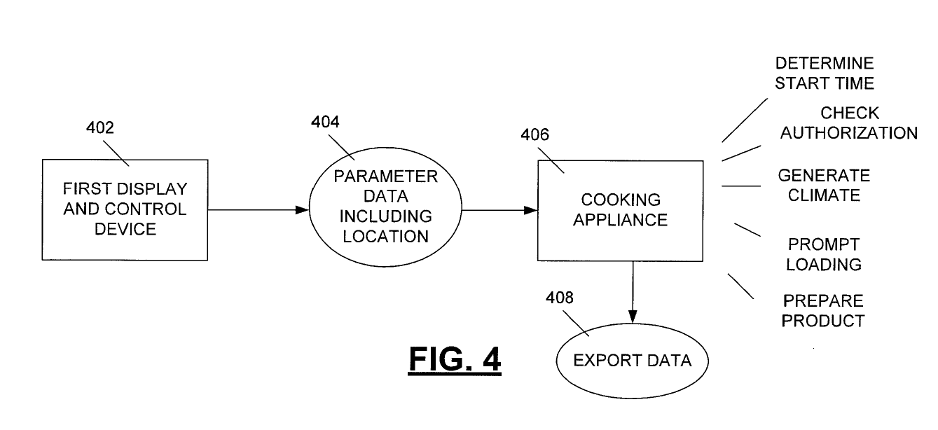

FIG. 4 depicts actions that may be taken by a cooking appliance upon receipt of location data from a display and control device. A mobile telephone or other display and control device 402 can also be used to adjust at least one parameter of the product to be cooked. For example, a menu can be provided on the mobile telephone for this purpose, by means of which a type of product to be cooked, a preparation of the product to be cooked, a degree of cooking, and an addition to the product to be cooked can be selected by using graphic symbols. Once the parameters of the product to be cooked have been selected, the parameters 404 can be transmitted by radio to a cooking appliance at a restaurant. A computing unit of this cooking appliance 406 can first check whether the mobile telephone in question is authorized to adjust the cooking appliance. If no desired time for consuming the desired dish has been transmitted together with the parameters of the product to be cooked via the mobile telephone, a time for completion of the cooking process can be calculated by determining the position of the mobile telephone using GPS, based on the assumption that the user of the mobile telephone is on his way to the restaurant where the cooking appliance is located. Afterwards, a dish is cooked in a similar manner to the method described in connection with an electronic menu. Once cooking has been completed, the dish can be served. For example a code which identifies the user or customer and which has been transmitted to the cooking appliance may be checked together with the parameters of the product to be cooked.

While examples have been used to disclose the invention, including the best mode, and also to enable any person of ordinary skill in the art to make and use the invention, the patentable scope of the invention is defined by the claims and may include other examples that occur to those of ordinary skill in the art. For example, as shown herein, the approaches disclosed herein may be implemented in different types of data processor environments which execute instructions to perform operations disclosed herein.

It is claimed:

1. A processor-implemented method for adjusting a cooking appliance by adjusting a first parameter related to a product to be cooked entered by a customer of a restaurant containing the cooking appliance using a first remote control device, said method comprising:
receiving a transmitted selection at the cooking device for the first parameter related to a product to be cooked, the selection being entered by a customer using a display at a remote control device;
automatically generating a climate at the cooking appliance based on the first parameter;
prompting loading of a product for cooking at the cooking appliance based on the first parameter upon generation of the climate; and
upon loading of a product, automatically preparing the product based on the first parameter.

2. The processor-implemented method of claim 1, further comprising:
receiving data for a second parameter identifying a location; and
determining a start time for automatically generating a climate based on the second parameter.

3. The processor-implemented method of claim 2, further comprising:
calculating an arrival time based on the second parameter;
calculating a completion time for preparing the product based on the arrival time; and
determining the start time for automatically generating the climate based on the completion time.

4. The processor-implemented method of claim 3, wherein the arrival time is calculated based on an estimated travel time from the location identified by the second parameter;
wherein the arrival time is calculated based on an assumption that a user of the remote control device is traveling to a restaurant containing the cooking appliance when the second parameter is received.

5. The processor-implemented method of claim 2, wherein the remote control device is a mobile telephone;
wherein the location is determined using GPS.

6. The processor-implemented method of claim 1, wherein the first parameter identifies a type of product to be cooked;
wherein the cooking apparatus prompts loading of the type of product to be cooked after the climate is generated according to the identified type of product to be cooked.

7. The processor-implemented method of claim 6, further comprising receiving a selection for a second parameter;
wherein the second parameter identifies an attribute selected from a group comprising:
a preparation style for the product to be cooked, a degree of cooking for the product to be cooked, a requested cooking completion time of day, and a side dish to accompany the product to be cooked.

8. The processor-implemented method of claim 1,
wherein the remote control device is in a restaurant containing the cooking device;
wherein the remote control graphically displays options for the first parameter;
wherein the remote control transmits the selection for the first parameter and location data identifying a table within the restaurant associated with the remote control.

9. The processor-implemented method of claim 1, further comprising:
receiving authorization data from the remote control; and
generating the climate at the cooking device upon verification of the authorization data.

10. The processor-implemented method of claim 1, further comprising:
exporting one or more parameters from the cooking appliance via the Internet, radio, or a portable storage device.

11. The processor-implemented method of claim 1, wherein the cooking appliance is an oven.

12. A cooking apparatus for cooking a product according to a first parameter entered by a customer of a restaurant containing the cooking apparatus using a first remote control device configured to perform steps comprising:
receiving at the cooking appliance a transmitted selection for the first parameter related to a product to be cooked, the selection being entered by the customer using a display at a remote control device;
automatically generating a climate at the cooking appliance based on the first parameter;
prompting loading of a product for cooking at the cooking appliance based on the first parameter upon generation of the climate; and
upon loading of a product, automatically preparing the product based on the first parameter.

13. The cooking apparatus of claim 12, further configured to perform steps comprising:
receiving data for a second parameter identifying a location; and
determining a start time for automatically generating a climate based on the second parameter.

14. The cooking apparatus of claim 13, further configured to perform steps comprising:
calculating an arrival time based on the second parameter;
calculating a completion time for preparing the product based on the arrival time; and
determining the start time for automatically generating the climate based on the completion time.

15. The cooking apparatus of claim 14, wherein the arrival time is calculated based on an estimated travel time from the location identified by the second parameter;
wherein a user of the remote control device is assumed to be traveling to a restaurant containing the cooking appliance when the second parameter is received.

16. The cooking apparatus of claim 13, wherein the remote control device is a mobile telephone;
wherein the location is determined using GPS.

17. The cooking apparatus of claim 12, wherein the first parameter identifies a type of product to be cooked;
wherein the cooking apparatus prompts loading of the type of product to be cooked after the climate is generated according to the identified type of product to be cooked.

18. The cooking apparatus of claim 17, wherein the cooking apparatus is further configured to receive a selection for a second parameter;
wherein the second parameter identifies an attribute selected from a group comprising:
a preparation style for the product to be cooked, a degree of cooking for the product to be cooked, a requested cooking completion time of day, and a side dish to accompany the product to be cooked.

19. The cooking apparatus of claim 12,
wherein the remote control device is in a restaurant containing the cooking device;
wherein the remote control graphically displays options for the first parameter;
wherein the remote control transmits the selection for the first parameter and location data identifying a table within the restaurant associated with the remote control.

20. The cooking apparatus of claim 12, wherein the cooking apparatus is further configured to perform steps comprising:
receiving authorization data from the remote control; and
generating the climate at the cooking device upon verification of the authorization data.
